(19) United States
(12) Patent Application Publication
(10) Pub. No.: US 2021/0221971 A1
(43) Pub. Date: Jul. 22, 2021

(54) FAST CURING EPOXY SYSTEM FOR PRODUCING RIGID FOAM AND USE OF THE FOAM IN COMPOSITES OR AS INSULATION MATERIAL

(71) Applicant: Evonik Operations GmbH, Essen (DE)

(72) Inventors: Melanie Sajitz, Shanghai (CN); Liyin Zhou, Shanghai (CN); Michael Vogel, Efringen-Kirchen (DE)

(73) Assignee: Evonik Operations GmbH, Essen (DE)

(21) Appl. No.: 17/269,719

(22) PCT Filed: Aug. 21, 2018
(86) PCT No.: PCT/CN2018/101583

§ 371 Date: Feb. 19, 2021

(51) Int. Cl. C08J 9/00; C08K 5/42; C08K 5/19; C08J 9/32; C08G 59/56

(52) U.S. Cl. CPC C08J 9/0033; C08K 5/42; C08K 5/19; C08J 2363/00; C08G 59/56; C08J 9/0028; C08J 9/32

(57) ABSTRACT

The present invention relates to a novel method for manufacturing rigid epoxy foams. Furthermore the present invention relates to materials, especially novel two-component epoxy systems that are used to conduct this method.

This novel process is characterized in that an epoxy resin is mixed with a blowing agent, especially an encapsulated blowing agent, and afterwards with an ionic liquid. Surprisingly the reaction, including foaming, starts at room temperature after a short time like after only 2 to 3 minutes.

In summary, the present invention comprises a two-component foam-in-place structural material and a process for producing a rigid epoxy foam.

### CROSS REFERENCE TO RELATED APPLICATIONS

This application is a 35 U.S.C. § 371 U.S. national phase entry of International Application No. PCT/CN2018/101583 having an international filing date of Aug. 21, 2018, which is incorporated herein by reference in its entirety.

### FIELD

The present invention relates to a novel method for manufacturing rigid epoxy foams. Furthermore the present invention relates to materials, especially novel two-component epoxy systems that are used to conduct this method.

This novel process is characterized in that an epoxy resin is mixed with a blowing agent, especially an encapsulated blowing agent, and afterwards with an ionic liquid. Surprisingly the reaction, including foaming, starts at room temperature after a short time like after only 2 to 3 minutes.

In summary, the present invention comprises a two-component foam-in-place structural material and a process for producing a rigid epoxy foam.

### BACKGROUND

Unless anything different is apparent from the context, the terms “composite system”, “composite material” and “composite” are used synonymously hereinafter.

Epoxy Systems are well known for their excellent adhesion, chemical and heat resistance, very good mechanical properties, and good electrical insulating properties.

Cured epoxy resin systems have found extensive applications ranging from adhesives, composites and coatings up to construction and flooring products.

Thereby, adhesives are generally based on two-component epoxy systems.

Epoxy composite are often produced with carbon fiber and fiberglass reinforcements.

An example for coating applications are protective coatings for metal surface.

In most applications the epoxy resin system consist of two components that can chemically react with each other and that form after mixing a cured epoxy, which is a hard, duroplastic material. The first component of this system is an epoxy resin, comprising epoxide groups, and the second component is a curing agent, often referred to as hardener. The curing agents include compounds which are reactive to these epoxide groups, such as amines, carboxylic acid or mercaptanes. For more details see H. Lee and K. Neville “Handbook of Epoxy Resins” McGraw Hill, New York, 1967, pages 5-1 to 5-24. The curing or crosslinking process is the chemical reaction of the epoxide groups in the epoxy resins and the reactive groups in the curing agents. The curing converts the epoxy resins, which have a relatively low molecular weight, into relatively high molecular weight or even crosslinked materials by chemical addition of the curing agents to the epoxy resins. Additionally, the curing agent can contribute to the properties of the cured epoxy material.

Fast curing and/or cold curing epoxy systems under ambient temperature are very useful in many applications like these discussed above or others like waterborne compositions. Modified amines, like Mannich bases, tertiary amines or its salts, (alkyl) phenol or Lewis acid are commonly used in these applications when cured under ambient temperature. Another example for a fast ambient cure epoxy system contains an accelerated polymercaptan.

Another technical field, in which epoxy curing systems can be used, are epoxy foams, which are of growing technical importance. These foams are especially used in applications like solid buoyancy material, sport (like in skis, tennis rags or lightweight bikes), automotive and construction. These rigid foams can be especially useful in applications with high demand on mechanical stability combined with a lower price than for example PMI foams, which has a better heat resistance.

EP 0 291 455 describes a cured foam with a high degree of closed cellular structure after it was exposed to heat at a temperature between 120 and 180° C. The mixture contains an epoxy resin or a mixture of epoxy resins, phenolic novolac (a curing agent), curing accelerator, a chemical blowing agent, which splits off nitrogen at temperatures above 100° C., and foam modifiers.

CN 2017/11268551 describes foam epoxy products for applications as solid buoyancy material. It comprises a liquid epoxy resin, a reactive diluent, a polyamine curing agent, anhydride curing agent or polyamide curing agent, a catalyst like tertiary amine or imidazole, hollow glass microspheres, polymer microspheres and other components like coupling agents. The system was cured and in mold foamed at a temperature of 80 to 120° C. The final solid buoyancy material has a density of 0.26 to 0.32 g/cm³.

US 2006/0188726 describes the design of expandable, thermally curable compositions based on epoxy resins, which exhibit a high degree of expansion from a mixture consisting of at least one liquid epoxy resin, one solid epoxy resin, one blowing agent, one curing agent and one mica-containing filler. The composition needs to be heated to temperatures between 60° C. and 110° C., preferably of 70° C. to 90° C. and then injected into the mold. The density of the cured rigid foam is between 0.47 and 0.64 g/cm³.

All of these disclosures described epoxy systems, which are foamed under external heating. This leads to several disadvantages. Especially when heating a bigger volume the temperature distribution within the resin shows gradients. This results in more or less inhomogeneous foams. It might be also necessary to use quite high temperatures to ensure a quick foaming. This even intensifies the temperature gradients and might also result in damaged surfaces or inner areas of the foam structure, especially in areas which have seen the highest temperature. Furthermore, an additional heating is cost intensive and time consuming. Additional time is needed for cooling down the final foam peace which is by itself a thermal insulator.

US 2002/0187305 describes a method, materials and products to manufacture a foamed product for foam-in-place structural reinforcement of hollow structures such as automobile cavities. This two-component system in which one component consists of an epoxy resin, a blowing agent having a thermoplastic shell filled with a solvent core, and a thixotropic filler. The second component is a mixture of an amine and a thixotropic filler and optionally particles comprising a thermoplastic shell filled with a solvent core. The exothermic reaction is created between the epoxy component and the amine component when combined. In one embodiment the heat generated by the exothermic reaction softens the thermoplastic shell of the particles and the solvent in the particle core can expand and function as a blowing agent. So the composition cures and foams at least partly simultaneous without adding any external heat. The resulting density of final products and the foaming time are not disclosed. Nevertheless, this method take a long time for foaming which is from a process perspective, especially throughput efficiency quite disadvantageous.

US 2005/0119372 describes a method, materials, and products which are similar to the disclosure of US 2002/0187305. Here a mixture of a piperazine and an amidoamine are used as amine component.

In a completely different technical field WO 2018/000125 discloses the use of ionic liquids for curing epoxy resins at room temperature. This new technology is used for producing adhesives, coatings, sealants, composite or alike. The influence on producing epoxy foams is neither discussed nor in any kind suggested. Because this system is very reactive, it would be supposed that foaming a composition containing ionic liquids would result in a rigid epoxy foam which might be effected by the higher heat. The process could be expected as to be a bit quicker due to the higher temperature, but it could be also expected that the foam might be inhomogeneous or even instable.

### SUMMARY

Against the background of the prior art discussed, a problem addressed by the present invention was therefore that of providing a novel process by means of which it is possible to produce epoxy foams, which are homogeneous and without any structural damage, especially on the foam surface.

A particular problem addressed by the present invention was that of providing a process in which this process can be conducted very quick and without any undue cooling time.

More in detail, the problem addressed by the present invention was that of providing a foaming procedure for producing epoxy foams, wherein the foaming is initiated and processed without adding any external heat.

In addition, independently of the individual embodiments expressed as problems, it is possible by the novel process to achieve fast cycle times for foaming, for example of down to less than 10 min.

In addition, independently of the individual embodiments expressed as problems, it is also to be possible by the novel process to epoxy foams comprising a relevant lower density compared to epoxy foams as known from the state of the art.

Moreover, an additional problem addressed by the present invention was that of providing an epoxy resin based systems which can be used in this process and which results after foaming in mechanical very stable rigid epoxy foams.

An additional problem to be solved by the present invention was to enable the process generating a rigid epoxy material formed in place, because the formulation parts are liquid.

Further problems not discussed explicitly at this point may be apparent hereinafter from the prior art, the description, the claims or working examples.

### DETAILED DESCRIPTION

The objects have been solved by providing a new process for producing a rigid epoxy foam. This new process comprises the following steps:
a. optionally mixing an epoxy resin with a blowing agent,
a2. optionally mixing a composition A, comprising an ionic liquid and optionally a second curing agent with a blowing agent,
b. mixing the epoxy resin, optionally comprising the blowing agent, with a composition A to form a composition B and
c. foaming composition B, comprising the epoxy resin, the blowing agent, the ionic liquid and optional at least one other curing agent, whereby no additional heating would be necessary.

Thereby it is especially preferred that the blowing agent is an encapsulated blowing agent.

It is especially preferred to conduct process step a and not a2.

There are several embodiments to conduct this new process. In one preferred variant process steps a. and b. are conducted simultaneously.

In an alternative embodiment the process step b. is conducted after process step a. Here it is especially preferred if the blowing agent, the ionic liquid and optional additional curing agents are mixed to the epoxy resin as one mixture.

As for process step c. it is especially a very useful embodiment to conduct this process step in a mold.

It was especially surprising that the process step of foaming the composition, containing the ionic liquids, was very quick and finished within less than 10 sec, sometimes even in a shorter time than 5 sec. Compared to this the foaming of a corresponding composition without ionic liquids, as it is described in US 2002/0187305, takes at least 25 sec. Taking into account that the exothermic curing of an epoxy resin containing the ionic liquids should be faster, this effect of additional energy would only explain a limited acceleration of the foaming down to maybe 15 to 20 sec. Therefore, the relevant shorter foaming time can be only explained by an additional effect of the ionic liquid on the blowing agent or the foaming process itself.

It has been also very surprisingly found that the ionic liquid shows in the process corresponding to the present invention not only a very good performance as epoxy resin curing agent, especially as a fast curing agent or as a cold curing agent.

Especially good results by conducting the process according to the present invention are possible when the ionic liquid is a room temperature ionic liquid (RTIL), formed by the reaction of a polyalkylene polyamines (following just mentioned as polyamine) and an organic acid. “Room temperature ionic liquid” (RTIL) salts, as utilized in the process corresponding to the present invention, include a salt in which the ions are poorly coordinated. This results in these compounds being in a stable liquid state at a temperature greater than about 15° C., especially at room temperature.

In a very preferred embodiment of the present invention the organic acid has a pKₐ of less than 6, and the polyamine has the following formula

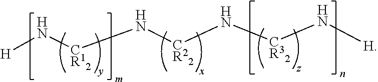

In this formula x, y and z are preferably integers of 2 and/or 3 and m and n are integers from 1 to 3. Furthermore preferred, R¹, R² and R³ are independently from each other selected from Hydrogen, linear or branched Alkyl groups comprising 1 to 12 C-atoms, benzyl derivate, hydroxyl alkyl groups or ether groups comprising 1 to 12 C-atoms and 1 to 6 O-atoms. Furthermore, it has to be noted that each of the two radicals R¹, R² respectively R³ can differ from each other, which means for example that a sequence between two amine atoms could have a structure like

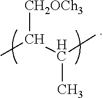

Especially preferred polyamines are selected from N, N′-bis-(3-aminopropyl) ethylenediamine, N, N, N′-tris-(3-aminopropyl) ethylenediamine, triethylenetetramine, tetraethylenepentamine or any combinations of these.

In especially preferred embodiments, the polyamine compound is a mixture of different polyalkylene polyamine compounds. Examples of suitable dissimilar polyalkylene polyamine compounds include, but are not limited to combinations of N, N′-bis (3-aminopropyl) ethylenediamine (Am4) and N, N, N′-tris (3-aminopropyl) ethylenediamine (Am5) or Am4 and triethylenetetramine (TETA) or Am4 and tetraethylenepentamine (TEPA).

It is well known by those skilled in the art that polyamines containing 4 or more nitrogen atoms are generally available as complex mixtures. In these complex mixtures. Thereby, it is also typical that a majority of these compounds comprise the same number of nitrogen atoms. Side products in these mixtures are mostly called congeners. As an example, complex mixtures of triethylenetetramine (TETA) contain not only linear TETA, but also tris-aminoethylamine, N, N′-bis-aminoethylpiperazine and 2-aminoethylaminoethylpiperazine.

It is also well known by the skilled in the polyamines might in part be protonated not only once, but twice or even three times and are present in the mixture as multi ions.

The corresponding organic acids, comprising a PKₐ below 6, are preferably selected from p-toluenesulfonic acid (p-TSA), trifluoromethanesulfonic acid (CF₃SO₃H), fluorosulfuric acid (FSO₃H), salicylic acid, trifluoroacetic acid (TFA), 2-ethylhexanoic acid (EHA), tetrafluoroboric acid (HBF₄), thiocyanic acid (HSCN) and combinations thereof.

In certain embodiments of the present disclosure, the molar ratio of the polyamine to the organic acid in a reaction mixture forming the reaction product is from greater than 0 to 1.8, especially from 0.1 to 1.8 and preferred between 0.3 and 1.3.

The ionic liquid salt comprises especially a liquid salt that is a stable liquid at a temperature greater than 15° C., stable at a temperature greater than 15° C. and up to about 150° C.; and in some cases greater than 15° C. up to about 200° C. In regard of the present invention the term“liquid” describes a state in which the salt has a viscosity of about 1000 cps to about 300,000 cps at a temperature of 25° C. Thereby, the term “stable” describes the liquid salt to be storage stable (maintain liquid state) for more than 1 month at a temperature of at least 15° C. It is also preferred that the inventive salt comprises an amine value of between 200 mg KOH/g and 1600 mg KOH/g, especially preferred between 400 mg KOH/g and 900 mg KOH/g.

In an optional embodiment of the present invention, the final composition, especially in form of primary composition A can further contain at least one additional curing agent, especially additional amines which differ from the polyamines described before and which are added for forming the ionic liquid. These additional amines may also have more than one nitrogen atom, but wouldn't form any kind of ionic liquid. Furthermore, these amines may be a primary, secondary or tertiary amine. It would be also possible to add a quaternary amine salt or derivatives of all kinds of these compounds. One specifically preferred example for such an additional amine would be a multifunction amine. Multifunctional amines, in sense of this invention, describes compounds which comprise three or more active amine hydrogen bonds.

Examples for these additional amines include, but are not limited to polyalkylene polyamines, which are different from the polyalkylene polyamines described before, cycloaliphatic amines, aromatic amines, poly (alkylene oxide) diamines or triamines, Mannich base derivatives, polyamide derivatives and combinations thereof. Other suitable additional amines as specific examples include, but are not limited to diethanolamine, morpholine and PC-23 as secondary amines, tris-dimethylaminomethylphenol (commercially available as Ancamine K54 from Evonik Industries), DBU and TEDA as tertiary amines. In addition the curable epoxy-based composition, especially composition A may include combinations of these amines or amine derivatives. The additional amines provide especially a function as a co-curing agent. In addition they work as toughener, diluent and/or accelerator. Further suitable additional amines include, but are not limited to aminoethylpiperazine, isophoronediamine (IPDA), 4, 4′-methylenebis-(cyclohexylamine) PACM, hydrogenated metaxylylene diamine (referred to often as 1, 3-BAC), 3, 3′-dimethyl-4, 4′-diaminodicyclohexyl methane (DMDC), polyether amine and combinations thereof. This additional amine may for example be present in composition A in a range between 0 and 60 wt %, especially between 10 and 40 wt %.

An even more detailed list of further optional examples of suitable additional amines can be found in WO 2018/000125.

As an less preferred alternative to the additional amines described before, it would be also possible to add mercaptanes, mixtures of more than one mercaptane or mixtures of mercaptanes and the additional amines as described before to the epoxy resin, especially to composition A.

By using a mixture of the ionic liquid and an additional curing agent, especially an additional amine like an aliphatic amine it is especially possible to adjust the pot life of the 2K system.

It is further preferred that the epoxy resin and/or composition A contain additives, stabilizers, dyes, colorants, fibers, pigments and/or fillers. Specifically preferred examples for these additives or stabilizers are flame retardants, UV stabilizers, UV absorbers, foam modifiers, adhesion promoters, thixotropic additives, rheology modifiers, emulsifiers or mixtures of at least two of these. The person skilled in the art knows or may easily identify which additives and/or stabilizers, especially known in the technical fields of rigid foam production or epoxy resins, can be selected and are most feasible for a composition as used in accordance to the present invention.

Furthermore, it is preferred that composition A comprises in addition a curing catalyst, which is especially preferred an organic acid having a pKₐ less than 6. This acid can, but must not be identical to the organic acid described before which is added to form the ionic liquids. Residual acid, especially if surplus organic acid was used for the ionic liquid forming, is especially preferred as additional curing catalyst.

The epoxy resin could be an aliphatic, cycloaliphatic, aromatic based epoxy resin or their mixture. Especially preferred the epoxy resin comprises in average more than one epoxide group per molecule. The epoxide group can be present as a glycidyl ether or glycidyl ester group. The epoxy resin can be used in liquid or solid state.

Epoxy resins are for example available from, but not limited to, diglycidyl ethers of bisphenol A (DGEBA), of bisphenol F or of bisphenol A/F (the designation A/F refers here to a mixture of acetone with formaldehyde which is used as the reactant in the preparation thereof). Commercially available examples are distributed under the trade names of Araldite GY 250, Araldite GY 282 (both distributed by Huntsman) or D.E.R.331, D.E.R.330 (both distributed by Dow Chemicals) or Epikote 828 (distributed by Hexion). Other examples are diglycidyl ethers of phenol novolacs or cresol novolacs. Such epoxy resins are commercially available under the tradenames EPN or ECN and Tactix R556 from Huntsman or as D.E.N. product series from Dow Chemicals. Further examples are aliphatic or cycloaliphatic based epoxy resins. Such epoxy resins are commercially available under the tradenames Epodil 741, Epodil 748, Epodil 777 from Evonik Industries.

As for the blowing agents, the person skilled in the art has a wide choice of potential useful alternatives. Examples given, but not limiting the invention in any kind, for particularly suitable blowing agents comprise tert-butanol, n-heptane, MTBE, methyl ethyl ketone, an alcohol having from one to six carbon atoms, water, methylal and/or urea.

In regard of the present invention, it is especially preferred to use encapsulated blowing agents. These encapsulated blowing agents are thermal expandable microspheres with a core shell structure. Thereby, the shell is preferably a thermoplastic shell which consists for example of acrylic-type resins such as poly methyl methacrylate, acrylic-modified polystyrene, poly vinylidene chloride, styrene/MMA copolymers or comparable thermoplastics. The core of the encapsulated blowing agent consists of a solvent such as low molecular-weight hydrocarbons. Useful hydrocarbons are for example ethane, ethylene, propane, propene, n-butane, isobutane, butene, isobutene, n-pentane, isopentane, neopentane, n-hexane, heptane, and petroleum ether. Further examples are chlorofluorocarbons, tetra alkyl silanes such as tetra methyl silane, tri methyl ethyl silane, tri methyl isopropyl silane, and tri methyl n-propylsilane. Other examples for the liquid in the core are the blowing agents listed above. Especially preferred among these examples are isobutane, n-butane, n-pentane, isopentane, n-hexane, petroleum ether, and mixtures thereof.

As for the composition B respectively the total kit as described below, the following more detailed composition is preferred:
The amount of the Epoxy resin is preferably between 20 and 80% by weight, especially preferably between 30 and 70% by weight and even more preferably between 40 and 60% by weight.
The amount of the ionic liquid is preferably between 5 and 60% by weight, especially preferably between 10 and 50% by weight and even more preferably between 15 and 45% by weight.
The amount of the blowing agent is preferably between 0.1 and 40% by weight, especially preferably between 1 and 30% by weight and even more preferably between 5 and 15% by weight.
The amount of optional further amines is preferably up to 30% by weight, especially preferably between 1 and 20% by weight and even more preferably between 5 and 15% by weight.
The total amount of optional additives and stabilizers is preferably up to 20% by weight, especially preferably between 0.1 and 15% by weight and even more preferably between 1 and 10% by weight.

Thereby, it has to be noted that the composition B is not limited to these components. Also other substances, like co-binders, could be present. Nevertheless, it wouldn't be favorable and thereby it is less preferred to add higher amounts of other components beside the listed above.

The heat which is generated by the reaction between ionic liquid and the epoxy resin softens the shell of the encapsulated blowing agent and thereby the solvent core can expand.

Encapsulated blowing agents are commercially available from, for example, but not limited to Expancel 461DU20, 461DU40, 093 DU120, 920DU40, all distributed by Akzo Nobel products. Other commercially available examples are F-35D, F-36D, F-190D and F-78D, distributed by Matsumoto products. Encapsulated blowing agent could be offered as specific core-shell materials or as mixtures of several of these microspheres.

The amount of the encapsulated blowing agent in the composition B could be up to 40% by total weight and is preferably between 0.1% and 40% by weight. It is especially preferred to use from 5 to 30% by total weight and absolutely preferred from 10 to 20% by total weight.

As for process step c), the foaming, following surprising aspects are also relevant: Compared to the state of the art the composition can cure and foam rapidly without adding any acrylic chemicals. It works well at room temperature and without providing any external heat. The full curing time depends on the composition and takes between 2 to 7 min from mixing of the raw materials to the end of the foaming/curing process. Therefore it improves the efficiency of the foaming and curing reaction and it can save energy.

After the mixing of the raw materials in a 2K process heat is released due to the epoxy and ultra-fast curing agent reaction in a short time, till an overall temperature of between 150 and 200° C. is reached. The system achieves therefore a higher expansion ratio and a lower density than expandable epoxy systems with normal polyamines, cyclo-aliphatic amines, aliphatic amines, polyamides and amidoamines at room temperature (see also comparative examples below). The majority of these amines do not show the same reaction behavior and if, they show the behavior only at elevated temperatures.

Compared to the known systems the final cured and foamed products have no odor. The mixture of epoxy resin such as Bisphenol-A epoxy resin and ultra-fast curing agent such as ionic liquid can cure very fast without catalyst. Most of the catalyst for the described systems are tertiary amines or phenol based tertiary amines, which have a very strong odor.

Due to the fact that the reaction takes place at room temperature and that there is no additional external heat necessary, because the reaction is exothermic. As a result there is no color change detected. That means the material does not decompose during the reaction which is a clear advantage over many known epoxy foam reactions described in the literature.

The process of the invention in particular has also the major advantage that it can be carried out with very short cycle times and can therefore be used with very good results in mass production.

It is very much preferred to produce the foam in a mold by means of in-mold foaming. By using a mold during the foaming step, it is advantageous that at the same time the product gets its final shape. Furthermore, it would be possible to use molds with a cooling mantle to cool the final foamed working peace in only short time what also shortens the circle time additionally.

As well as the process described before, also a kit for producing rigid epoxy foams is part of the present invention. This kit, according to the present invention, comprises an epoxy resin, an encapsulated blowing agent and a component A, whereby component A comprises an ionic liquid and an optional additional curing agent. Thereby, the single components correspond to the description above.

For this kit it is especially preferred that it consists of a) a mixture and b) the component A, whereby the mixture comprises the epoxy resin and the encapsulated blowing agent. In an alternative, also preferred embodiment of the present invention the Kit comprises a) the epoxy resin, and b) a mixtures of the encapsulated blowing agent and the component A.

Last, but not least also a novel rigid epoxy foam, characterized in that the foam contains an ionic liquid, is part of the present invention.

Particular preference is given to a corresponding rigid epoxy foam within the density range from 20 to 550 kg/m3, preferably from 25 to 220 kg/m3 and more preferably from 50 to 110 kg/m3.

The present invention, especially in regard of use of the foam according to the invention, can be utilized to manufacture composite parts for the automotive industry, shipbuilding or aerospace industry, for thermal or acoustic insulation materials, for construction and for making sport instruments like skis or tennis rags. These examples given are not limiting the present invention in any kind.

### EXAMPLES

In context of the present invention, especially in regard of the claims, the description and the following examples, the glass transition temperatures were measured via a differential scanning calorimetry (DSC). In context of this invention a Perkin Elmer equipment was used to determine the Glass transition temperature Tg (DSC-8000, Perkin Elmer).

Detailed DSC Procedure Description:

The sample was weighed (accurate to ±1.0 mg) and the equipment was purged with nitrogen for 5 minutes before testing. The sample was hold for 2 minutes at a temperature of −40° C., afterwards it was heated from −40° C. to 200° C. with a heating rate of 20° C./min. In the next phase the sample was cooled from 200° C. to −40° C. again with a cooling rate of 200° C./min and hold for additional 2 min at −40° C. Then it was heated again from −40° C. to 200° C. with a heating rate of 20° C./min. The final T_{g} was determined from this second heating circle. Afterwards, the result of the T_{g} determination was confirmed with a second DSC scan. These test conditions are according to the test standard GB/T 19466.2-2004 “plastics DSC determination of glass transition temperature”.

### Example 1

The following Examples serve to illustrate the invention. Ancamine 2914UF is an ultra-fast ionic liquid curing agent from Evonik. Also aliphatic and cycloaliphatic amines are used for the investigation (see table 1).

Process Description 1:

The first step is the mixing of the epoxy resin together with a blowing agent (encapsulated blowing agent) at room temperature with a speed mixer (800 rpm) for 1 minute to form part A. The second process step is to add the part B, an amine curing component and mix it at room temperature with a speed mixer (800 rpm) for 30 seconds. The foaming and curing reaction starts after the mixing at room temperature.

### Example 1.1

Part A, consisting of 25 g epoxy resin together with 2.5 g blowing agent (Microsphere F35D), is mixed at room temperature in a speed mixer with Part B: consisting of 12.5 g amine curing component according to the described procedure. The foaming and curing reaction starts after 220 seconds and is finished after 321 seconds. The temperature of the exothermic reaction is 190° C. The 2K system generates a foam with a density of 0.095 g/cm³.

As for comparative example 1.2 to 1.6, the process is the same as described for example 1.1 (process description 1). Differences regarding the composition and observations in regard of the reaction are listed in table 1.

TABLE 1
Different curing agent for foam epoxy formulation

| | | Example | Comp. | Comp. | Comp. | Comp. | Comp. |
|---|---|---|---|---|---|---|---|
| | | 1.1 | Ex. 1.2 | Ex 1.3 | Ex 1.4 | Ex 1.5 | Ex 1.6 |
| Part A | DER331 | 90.9 | 90.9 | 90.9 | 90.9 | 90.9 | 90.9 |
| (wgt %) | Microsphere | 9.1 | 9.1 | 9.1 | 9.1 | 9.1 | 9.1 |
| | F35D^{[1]} | | | | | | |
| Part B | Ancamine | 100 | | | | | |
| (wgt %) | 2914UF | | | | | | |
| | Ancamide 350A | | 100 | | | | |
| | Ancamine | | | 100 | | | |
| | TETA | | | | | | |
| | Ancamine 2636 | | | | 100 | | |
| | Jeffamine D230 | | | | | 100 | |
| | Vestamin IPD | | | | | | 100 |

| | | | | | | |
|---|---|---|---|---|---|---|
| Stoichiometry | 1:1 | 1:1 | 1:1 | 1:1 | 1:1 | 1:1 |
| Total weight (g) | 40 | 40 | 40 | 40 | 40 | 40 |
| Density(g/cm3) | 0.095 | No | 0.126 | 0.156 | No | No |
| Start foam time (Sec) | 220 | foam | 2194 | 782 | foam | foam |
| End foam time (Sec) | 321 | | 2509 | 1145 | | |
| Start foam temperature(° C.) | 58 | | 63 | 62 | | |
| Max foam temperature(° C.) | 190 | | 190 | 175 | | |
| Tg DSC 20° C./min (° C.) | 75.0 | | 121.5 | 98.7 | | |

^{[1]}Thermal expandable microsphere from Matsumoto.

The data of table 1 show that example 1.1, which was based on the ionic liquid Ancamine 2914UF starts foaming/curing much faster than the other amines which were disclosed in prior arts (comparative examples 1.2 to 1.6). The density of the rigid foam is with 0.095 g/m³ much lower than for the other amines.

### Example 2

For example 2.7 to 2.9 the foam was generated according to the process described for example 1.1.

TABLE 2
Different grade thermal expandable microsphere for
foam epoxy formulation Examples 1.1 and 2.7-2.9

| | | Example | Example | Example | Example |
|---|---|---|---|---|---|
| | | 1.1 | 2.7 | 2.8 | 2.9 |
| Part A | DER331 | 90.9 | 90.9 | 90.9 | 90.9 |
| (wgt %) | Microsphere F35D^{[2]} | 9.1 | | | |
| | Microsphere F-78KD^{[2]} | | 9.1 | | |
| | Expancel 031DU40^{[3]} | | | 9.1 | |
| | Expancel 461DU40^{[3]} | | | | 9.1 |
| Part B | Ancamine2914UF | 100 | 100 | 100 | 100 |
| (wgt %) | | | | | |

| | | | | |
|---|---|---|---|---|
| Stoichiometry | 1:1 | 1:1 | 1:1 | 1:1 |
| Total weight (g) | 40 | 40 | 40 | 40 |
| Density (g/cm3) | 0.095 | 0.126 | 0.105 | 0.188 |
| Start foam time (sec) | 220 | 283 | 257 | 269 |
| End foam time (sec) | 321 | 344 | 341 | 377 |
| Start foam temperature (° C.) | 58 | 80 | 68 | 67 |
| Max foam temperature (° C.) | 190 | 188 | 188 | 192 |
| Tg DSC 20° C./min (° C.) | 75.0 | 75.1 | 75.3 | 74.0 |
| Odor of final foamed | 1 | 1 | 1 | 1 |
| products at room temperature | | | | |
| (1 = no, 2 = Slightly, | | | | |
| 3 = obviously, 4 = strong | | | | |

^{[2]}: Thermal expandable microsphere from Matsumoto
^{[3]}: Thermal expandable microsphere from AkzoNobel

The results listed in table 2 show that thermal expandable microsphere from different supplier could be used as blowing agent for ionic liquid formulation. The foam time and density of final foamed products were effected by the grade of thermal expandable microsphere blowing agent. For example 2.7 to 2.9, the process is the same as for example 1.1 (process description 1).

### Example 3

For examples 3.10 to 3.12, the first step is the mixing of 26.47 g epoxy resin together with 0.26 g blowing agent (encapsulated blowing agent, Microsphere F35D) at room temperature with a speed mixer. In a second process step 13.27 g amine curing component ionic liquid is added to the composition according to the process as described for example 1. The foaming and curing reaction starts after the mixing at room temperature. The exact compositions and results are listed in table 3.

TABLE 3
Different blowing agent concentration for foam epoxy formulation

| | | Example | Example | Example | Example |
|---|---|---|---|---|---|
| | | 3.10 | 3.11 | 1.1 | 3.12 |
| Part A | DER331 | 99.03 | 95.28 | 90.9 | 83.28 |
| (wgt %) | Microsphere F35D | 0.97 | 4.72 | 9.1 | 16.72 |
| Part B | Ancamine2914UF | 100 | 100 | 100 | 100 |
| (wgt %) | | | | | |

| | | | | |
|---|---|---|---|---|
| Stoichiometry | 1:1 | 1:1 | 1:1 | 1:1 |
| Total weight (g) | 40 | 40 | 40 | 40 |
| Density (g/cm3) | 0.361 | 0.152 | 0.095 | 0.050 |
| Start foam time (sec) | 210 | 213 | 220 | 206 |
| End foam time (sec) | 263 | 300 | 321 | 306 |
| Start foam temperature (° C.) | 58 | 63 | 58 | 56 |
| Max foam temperature (° C.) | 189 | 193 | 190 | 190 |
| Odor of final foamed products at room | 1 | 1 | 1 | 1 |
| temperature | | | | |
| ( 1 = no, 2 = Slightly | | | | |
| 3 = obviously, 4 = strong | | | | |

In table 3 the influence of the blowing agent concentration on the density of final foamed products can be seen. As expected the density is decreasing with increasing concentration. On the other hand the blowing agent concentration didn't have any observable effect on foaming time or the foam temperature.

### Example 4

Process Description 2:

For example 4.13, the first step is the mixing of 25 g epoxy resin and 2.5 g encapsulated blowing agent at room temperature with a speed mixer (800 rpm; mixing for 1 minute). Mixture and curing agent were stored for at least 1h at temperatures of 10° C., 25° C. respectively 40° C. The second process step is the addition of 12.5 g ionic liquid as amine curing component to the composition. Afterwards the composition was mixed for 30 seconds at room temperature with a speed mixer (800 rpm). The foaming and curing reaction starts after the mixing at different temperature as can be seen in table 4.

TABLE 4
Different low temperatures for foam
epoxy formulation (example 4.13-4.14)

| | | Example | Example | Example |
|---|---|---|---|---|
| | | 4.13 | 1.1 | 4.14 |
| Part A | DER331 | 90.9 | 90.9 | 90.9 |
| (wgt %) | Microsphere F35D | 9.1 | 9.1 | 9.1 |
| Part B | Ancamine2914UF | 100 | 100 | 100 |
| (wgt%) | | | | |

| | | | |
|---|---|---|---|
| Stoichiometry | 1:1 | 1:1 | 1:1 |
| Total weight (g) | 40 | 40 | 40 |
| Ambient temperature (° C.) | 10 | 25 | 40 |
| Density (g/cm3) | 0.103 | 0.095 | 0.086 |
| Start foam time (sec) | 335 | 220 | 60 |
| End foam time (sec) | 483 | 321 | 160 |
| Start foam temperature (° C.) | 56 | 58 | 57 |
| Max foam temperature (° C.) | 175 | 190 | 189 |
| Tg DSC 20° C./min (C.) | 74.9 | 75.0 | 77.2 |
| Odor of final foamed products | 1 | 1 | 1 |
| at room temperature | | | |
| ( 1 = no, 2 = Slightly | | | |
| 3 = obviously , 4 = strong | | | |

These results in tables 4 demonstrate that the formulation can be used for foaming at a quite wide range of ambient temperatures. Therefore, the system is easy to use under varying conditions or climates. It can even be foamed at low temperatures of only 10° C. Lower temperatures only lead to a longer foaming and curing time.

### Example 5

Process Description 3:

As for examples 5.15 to 5.19, the first step is the mixing of 25 g epoxy resin and 2.5 g encapsulated blowing agent for 1 minute at room temperature with a speed mixer (800 rpm). The resulting mixture of part A was divided in several samples. Different samples were stored at 23° C. for 1 day, 7 days, 14 days, 21 days and 30 days. After storing for different periods the ionic liquid was added to the samples as part B (second process step). Afterwards the composition was mixed for 30 seconds at room temperature with a speed mixer (800 rpm). The foaming and curing reaction starts after the mixing at room temperature. The results are shown in table 5.

TABLE 5
Storage stability test (Part A)

| | | Example | Example | Example | Example | Example | Example |
|---|---|---|---|---|---|---|---|
| | | 1.1 | 5.15 | 5.16 | 5.17 | 5.18 | 5.19 |
| Part A | DER331 | 90.9 | 90.9 | 90.9 | 90.9 | 90.9 | 90.9 |
| (wgt %) | Microsphere | 9.1 | 9.1 | 9.1 | 9.1 | 9.1 | 9.1 |
| | F35D | | | | | | |
| Part B | Ancamine2914UF | 100 | 100 | 100 | 100 | 100 | 100 |
| (wgt %) | | | | | | | |

| | | | | | | |
|---|---|---|---|---|---|---|
| Stoichiometry | 1:1 | 1:1 | 1:1 | 1:1 | 1:1 | 1:1 |
| Total weight (g) | 40 | 40 | 40 | 40 | 40 | 40 |
| Storage time (days) | 0 | 1 | 7 | 14 | 21 | 30 |
| Density(g/cm3) | 0.095 | 0.092 | 0.090 | 0.095 | 0.093 | 0.094 |
| Start foam time(sec) | 220 | 232 | 240 | 233 | 242 | 238 |
| End foam time (sec) | 321 | 328 | 324 | 329 | 342 | 341 |
| Start foam temperature(° C.) | 58 | 61 | 62 | 61 | 63 | 60 |
| Max foam temperature(° C.) | 190 | 188 | 192 | 189 | 190 | 190 |

After storing at 23° C. for a time between 1 and 30 days, no changes of the foam density, foaming time and temperature during the foaming were detected. For some of the samples a phase separation could be observed during the storage. This phase separation had no significant influence on the foaming.

### Example 6

Process Description 4:

12.5 g of the ionic liquid curing agent were mixed with 2.5 g encapsulated blowing agent at room temperature with a speed mixer (800 rpm for 1 minute) to form part B. Different samples of the mixture were stored at 23° C. for 1 day, 7 days, 14 days, 21 days respectively 30 days. After storing the epoxy resin part A was added to the single samples. The mixing itself was conducted at room temperature with a speed mixer (800 rpm for 30 seconds). The foaming and curing reaction starts after the mixing at room temperature. The results are shown in table 6.

TABLE 6
Storage stability test (Part B)

| | | Example | Example | Example | Example | Example | Example |
|---|---|---|---|---|---|---|---|
| | | 6.20 | 6.21 | 6.22 | 6.23 | 6.24 | 6.25 |
| Part A | DER331 | 100 | 100 | 100 | 100 | 100 | 100 |
| (wgt %) | | | | | | | |
| Part B | Ancamine2914UF | 83.33 | 83.33 | 83.33 | 83.33 | 83.33 | 83.33 |
| wgt %) | Microsphere F35D | 16.67 | 16.67 | 16.67 | 16.67 | 16.67 | 16.67 |

| | | | | | | |
|---|---|---|---|---|---|---|
| Stoichiometric | 1:1 | 1:1 | 1:1 | 1:1 | 1:1 | 1:1 |
| Total (g) | 40 | 40 | 40 | 40 | 40 | 40 |
| Storage time (days) | 0 | 1 | 7 | 14 | 21 | 30 |
| Density(g/cm3) | 0.095 | 0.096 | 0.091 | 0.095 | 0.094 | 0.096 |
| Start foam time(sec) | 220 | 230 | 230 | 233 | 230 | 235 |
| End foam time (sec) | 321 | 346 | 340 | 329 | 338 | 347 |
| Start foam temperature(° C.) | 58 | 59 | 61 | 61 | 62 | 62 |
| Max foam temperature(° C.) | 190 | 189 | 191 | 189 | 192 | 189 |

After storing at 23° C. for a storage time between 1 and 30 days no changes for the foam density, foaming time and temperature during the foaming were detected. For some of the samples a phase separation could be observed during the storage, which had no significant influence.

### Example 7.1

Process Description 5:

A sample of example 1.1 is stored as a control sample in a dark flask. Another sample of example 1.1. was exposed to sun light for several days.

TABLE 7.1
Color stability test after exposure to sun light, example 1.1

| | Color change (0 = no change, 1 = a little change, |
|---|---|
| | 2 = change, 3 = totally change) |
| 7 days | 0 |
| 14 days | 0 |
| 21 days | 0 |
| 30 days | 0 |

The results show that there is no decomposition over time and the color remains stable.

### Comparative Example 7.2

Similar to Example 1.1. and according to procedure 1 a rigid foam was produced with a common curing agent TETA. After the foaming and curing reactions the sample of example 7.2 was stored as a control sample in a dark flask. Another sample of example 7.2 was exposed to sun light for several days. The results show that the foam is yellowing over time (see table 7.2).

TABLE 7.2
Color stability test after exposure to sun light, example 7.2 (TETA)

| | Color change (0 = no change, 1 = a little change, |
|---|---|
| | 2 = change, 3 = totally change) |
| 7 days | 0 |
| 14 days | 0 |
| 21 days | 0 |
| 30 days | 0 |

### Example 8.1

Process Description 6:

The rigid foam products produced according to the invention show no odor after foaming after cooling to room temperature. Potential odor has been investigated by five different persons at samples of foams according to examples 1.1, 3.10 and 3.12 directly after foaming and cooling as well as after storing these samples for more than one day in a closed glass bottle. As well directly as after storage the sample no odor was detected for the sample by any of the testing persons.

### Comparative Example 8.2

Similar to Example 1.1. and according to procedure 1 a rigid foam was produced with a common curing agent TETA. Also here the odor was tested following process 6. Directly after foaming and cooling as well as after storing of these samples significant odor was noticed. Thereby, the odor was a little reduced after storing.

TABLE 8.1
Odor of foam epoxy products

| | | Example 1.1 | Comp. Ex 1.3 |
|---|---|---|---|
| Part A | DER331 | 90.9 | 90.9 |
| (wgt %) | Microsphere F35D | 9.1 | 9.1 |
| Part B | Ancamine 2914UF | 100 | |
| wgt %) | Ancamine TETA | | 100 |

| | | |
|---|---|---|
| Stoichiometry | 1:1 | 1:1 |
| Total weight (g) | 40 | 40 |
| Odor of final foamed products | 1 | 1 |
| at room temperature | | |
| (1 = no, 2 = Slightly | | |
| 3 = obviously, 4 = strong | | |

### Example 9.1

Similar to examples 3.11 to 3.12. and according to procedure 1 a rigid foam was produced with ionic liquid curing agent. The exact compositions and results are listed in table 9.1. The compressive strength of examples in table 9.1 was tested according to the test method ISO844.

TABLE 9.1
Compressive strength of different blowing agent concentration foam epoxy system

| | | Example | Example | Example |
|---|---|---|---|---|
| | | 3.11 | 1.1 | 3.12 |
| Part A | DER331 | 95.28 | 90.9 | 16.72 |
| (wgt %) | Microsphere F35D | 4.72 | 9.1 | 16.72 |
| Part B | Ancamine2914UF | 100 | 100 | 100 |
| (wgt %) | | | | |

| | | | |
|---|---|---|---|
| Stoichiometry | 1:1 | 1:1 | 1:1 |
| Total weight (g) | 40 | 40 | 40 |
| Density (g/cm3) | 0.152 | 0.095 | 0.050 |
| Compressive strength (KPa) | 405 | 311 | 213 |

The amount of microsphere (encapsulated blowing agent) in the composition determines the compressive strength of the rigid foam. As more microsphere is used as lower is the density but also the compressive strength of the rigid foam. Therefore the composition must be adjusted according to the appropriate end application needs.

1. A process for producing a rigid epoxy foam, wherein the process comprises the following steps:
a. optionally mixing an epoxy resin with a blowing agent,
a2. optionally mixing a composition A, comprising an ionic liquid and optionally a second curing agent with a blowing agent,
b. mixing the epoxy resin, optionally comprising the blowing agent, with composition A, to form a composition B and
c. foaming composition B, comprising the epoxy resin, the blowing agent, the ionic liquid and optional at least one other curing agent, whereby no additional heating would be necessary.

2. The process according to claim 1, wherein the blowing agent is an encapsulated blowing agent.

3. The process according to claim 1, wherein the ionic liquid is a room temperature ionic liquid, formed by the reaction of a polyamine and an organic acid, whereby the organic acid having a pKₐ of less than 6, and whereby the polyamine has the following formula 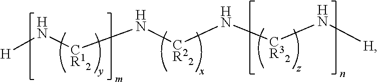
wherein x, y and z are integers of 2 and/or 3, m and n are integers from 1 to 3 and R¹, R² and R³ are independently from each other selected from Hydrogen, linear or branched Alkyl groups comprising 1 to 12 C-atoms, benzyl derivate, hydroxyl alkyl groups or ether groups comprising 1 to 12 C-atoms and 1 to 6 O-atoms, whereby each of the two radicals R¹, R² respectively R³ can differ from each other.

4. The process according to claim 3, wherein the organic acid is selected from p-toluenesulfonic acid, trifluoromethanesulfonic acid, fluorosulfuric acid, salicylic acid, trifluoroacetic acid, 2-ethylhexanoic acid, tetrafluoroboric acid, thiocyanic acid and combinations thereof.

5. The process according to claim 3, wherein the ratio between the polyamine and the organic acid is between 0.1 and 1.8, preferred between 0.3 and 1.3.

6. The process according to claim 3, wherein the polyamine is selected from N, N′-bis-(3-aminopropyl) ethylenediamine, N, N, N′-tris-(3-aminopropyl) ethylenediamine, triethylenetetramine, tetraethylenepentamine or any combinations of these.

7. The process according to claim 1, wherein process steps a. and b. are conducted simultaneously.

8. The process according to claim 1, wherein first process step b. is conducted after process step a.

9. The process according to claim 7, wherein the blowing agent, the ionic liquid and optional additional curing agents are mixed to the epoxy resin as one mixture.

10. The process according to claim 1, wherein process step c is conducted in a mould.

11. The process according to claim 1, wherein epoxy resin and/or composition A contain additives, stabilizers, dyes, colorants, fibers, pigments and/or fillers.

12. The process according to claim 11, wherein the additives or stabilizers are flame retardants, UV stabilizers, UV absorbers, foam modifiers, adhesion promoters, thixotropic additives, rheology modifiers, emulsifiers or mixtures of at least two of these.

13. The process according to claim 1, wherein composition A comprises the ionic liquid and another amine curing agent.

14. The process according to claim 13, wherein the second curing agent is selected from list comprising primary amines, secondary amines, tertiary amines, quaternary amine compounds, mercaptans and combinations thereof.

15. The process according to claim 1, wherein composition A comprises in addition a curing catalyst, preferred an organic acid having a pKₐ less than 6.

16. A kit for producing a rigid epoxy foam, wherein the kit comprises an epoxy resin, an encapsulated blowing agent and a component A, whereby component A comprises an ionic liquid and an optional additional curing agent.

17. The kit according to claim 16, wherein the kit comprises a) a mixture of the epoxy resin and the encapsulated blowing agent, and b) the component A.

18. The kit according to claim 16, wherein the kit comprises a) the epoxy resin, and b) a mixtures of the encapsulated blowing agent and the component A.

19. A rigid epoxy foam, wherein the foam contains an ionic liquid.

20. The process according to claim 1, wherein the process includes
a2. mixing a composition A, comprising an ionic liquid and a second curing agent with a blowing agent.
